(19) United States
(12) Patent Application Publication
(10) Pub. No.: US 2025/0327649 A1
(43) Pub. Date: Oct. 23, 2025

(54) METHOD AND SYSTEM FOR BALLISTIC SPECIMEN CLUSTERING

(71) Applicant: FORENSIC TECHNOLOGY (CANADA) INC., St-Laurent (CA)

(72) Inventors: Danny ROBERGE, St-Bruno (CA); Alain BEAUCHAMP, Montreal (CA); Serge LEVESQUE, Lachine (CA)

(21) Appl. No.: 18/870,427

(22) PCT Filed: May 30, 2023
(86) PCT No.: PCT/CA2023/050737

§ 371 Date: Nov. 28, 2024

Related U.S. Application Data
(60) Provisional application No. 63/346,927, filed on May 30, 2022.

(51) Int. Cl. F42B 35/00; G06V 10/74; G06V 10/762

(52) U.S. Cl. CPC F42B 35/00; G06V 10/761; G06V 10/7625

(57) ABSTRACT

There are described a method and a system for generating clusters of ballistic specimens. Using an image acquisition tool, topographic data for at least three ballistic specimens of at least one region of interest is acquired. From the topographic data, at least one parameter characterizing optimal toolmark alignment is determined for every distinct pair of the at least three ballistic specimens, each ballistic specimen having a plurality of toolmarks formed thereon. From the topographic data, at least one pairwise similarity score associated with optimal toolmark alignment is determined for every distinct pair of the at least three ballistic specimens. At least one triplet-wise consistency measure indicative of a consistency of optimal toolmark alignment is determined for every distinct triplet of the at least three ballistic specimens. A cluster analysis is conducted based on the at least one similarity score and the at least one consistency measure to generate the clusters.

### CROSS-REFERENCE TO RELATED APPLICATIONS

The present application claims the benefit of U.S. Provisional Patent Application No. 63/346,927 filed on May 30, 2022, the contents of which are hereby incorporated by reference.

### TECHNICAL FIELD

The present disclosure relates generally to automated ballistic identification, and more specifically to comparing toolmarks of ballistic specimens for determining groups of matches.

### BACKGROUND OF THE ART

The determination of whether or not two or more sets of firearm toolmarks were produced by a common or different source can be based on the qualitative similarity of optimally aligned toolmarks, as judged by an expert from his experience and training. High-resolution three-dimensional (3D) microscopy provides a more quantitative approach, where similarity scores are based on high-resolution topographic measurements.

Automated ballistic identification systems provide scores that quantify the level of similarity for pairs of specimens of the same type. In case more than two specimens of the same type are compared, cluster analysis based on the similarity scores computed over all distinct pairs of specimens can be performed. Each resulting cluster represents a group of ballistic specimens that potentially originate from a common source. Therefore, these clusters may be tentatively associated with distinct firearms, some of which may not be physically available, especially if the ballistic specimens have been collected at different crime scenes.

Score-based clustering algorithms can effectively support expert analysis, particularly in situations where pairs of specimens clearly come from a common source or a different source. However, these algorithms cannot always handle the most difficult specimens. In such cases, changing the clustering threshold involves either merging clusters that would normally have been linked to different firearms or splitting valid clusters. Additional information, complementing the similarity scores, as well as clustering methods specifically designed to handle it, are therefore needed.

Therefore, improvements are needed.

### SUMMARY

In a first broad aspect, there provided a method for generating clusters of ballistic specimens. The method comprises acquiring, using an image acquisition tool, topographic data for at least three ballistic specimens of at least one region of interest, determining, at a computing device, from the topographic data, at least one parameter characterizing optimal toolmark alignment for every distinct pair of the at least three ballistic specimens, each ballistic specimen having a plurality of toolmarks formed thereon, determining, at the computing device, from the topographic data, at least one pairwise similarity score associated with optimal toolmark alignment for every distinct pair of the at least three ballistic specimens, determining, at the computing device, at least one triplet-wise consistency measure indicative of a consistency of optimal toolmark alignment for every distinct triplet of the at least three ballistic specimens, and conducting, at the computing device, a cluster analysis based on the at least one similarity score and the at least one consistency measure to generate the clusters of ballistic specimens.

In some embodiments, the at least one consistency measure is determined based on a planar rotation of the at least three ballistic specimens having toolmarks of a same type.

In some embodiments, the at least one consistency measure is determined based on a planar translation of the at least three ballistic specimens having toolmarks of a same type.

In some embodiments, the at least one consistency measure is determined based on a planar rotation and a planar translation of the at least three ballistic specimens having toolmarks of a same type.

In some embodiments, the at least one consistency measure is determined based on a relative planar rotation of the at least three ballistic specimens having toolmarks of two different types.

In some embodiments, the at least one consistency measure is determined based on a relative planar translation of the at least three ballistic specimens having toolmarks of two different types.

In some embodiments, the at least one consistency measure is determined based on a relative planar translation and a relative planar rotation of the at least three ballistic specimens having toolmarks of two different types.

In some embodiments, the at least one consistency measure is determined based on a translation and a relative scale factor of the at least three ballistic specimens.

In some embodiments, the topographic data is acquired for the at least three ballistic specimens comprising cartridge cases.

In some embodiments, the topographic data is acquired for the at least three ballistic specimens comprising bullets.

In some embodiments, the at least one consistency measure is determined based on a phase score of land engraved area (LEA) comparisons of the bullets.

In a second broad aspect, there is provided a system for generating clusters of ballistic specimens. The system comprises at least one processing unit and at least one non-transitory computer-readable memory having stored thereon program instructions executable by the processing unit for acquiring, using an image acquisition tool, topographic data for at least three ballistic specimens of at least one region of interest, determining, at a computing device, from the topographic data, at least one parameter characterizing optimal toolmark alignment for every distinct pair of the at least three ballistic specimens, each ballistic specimen having a plurality of toolmarks formed thereon, determining, at the computing device, from the topographic data, at least one pairwise similarity score associated with optimal toolmark alignment for every distinct pair of the at least three ballistic specimens, determining, at the computing device, at least one triplet-wise consistency measure indicative of a consistency of optimal toolmark alignment for every distinct triplet of the at least three ballistic specimens, and conducting, at the computing device, a cluster analysis based on the at least one similarity score and the at least one consistency measure to generate the clusters of ballistic specimens.

In some embodiments, the program instructions are executable by the processing unit for determining the at least one consistency measure based on a planar rotation of the at least three ballistic specimens having toolmarks of a same type.

In some embodiments, the program instructions are executable by the processing unit for determining the at least one consistency measure based on a planar translation of the at least three ballistic specimens having toolmarks of a same type.

In some embodiments, the program instructions are executable by the processing unit for determining the at least one consistency measure based on a planar rotation and a planar translation of the at least three ballistic specimens having toolmarks of a same type.

In some embodiments, the program instructions are executable by the processing unit for determining the at least one consistency measure based on a relative planar rotation of the at least three ballistic specimens having toolmarks of two different types.

In some embodiments, the program instructions are executable by the processing unit for determining the at least one consistency measure based on a relative planar translation of the at least three ballistic specimens having toolmarks of two different types.

In some embodiments, the program instructions are executable by the processing unit for determining the at least one consistency measure based on a relative planar rotation and a relative planar translation of the at least three ballistic specimens having toolmarks of two different types.

In some embodiments, the program instructions are executable by the processing unit for determining the at least one consistency measure based on a translation and a relative scale factor of the at least three ballistic specimens.

In some embodiments, the program instructions are executable by the processing unit acquiring the topographic data for the at least three ballistic specimens comprising cartridge cases.

In some embodiments, the program instructions are executable by the processing unit for acquiring the topographic data for the at least three ballistic specimens comprising bullets.

In some embodiments, the program instructions are executable by the processing unit for determining the at least one consistency measure based on a phase score of land engraved area (LEA) comparisons of the bullets.

In a third broad aspect, there is provided a computer readable medium having stored thereon program code executable by a processor for acquiring, using an image acquisition tool, topographic data for at least three ballistic specimens of at least one region of interest, determining, at a computing device, from the topographic data, at least one parameter characterizing optimal toolmark alignment for every distinct pair of the at least three ballistic specimens, each ballistic specimen having a plurality of toolmarks formed thereon, determining, at the computing device, from the topographic data, at least one pairwise similarity score associated with optimal toolmark alignment for every distinct pair of the at least three ballistic specimens, determining, at the computing device, at least one triplet-wise consistency measure indicative of a consistency of optimal toolmark alignment for every distinct triplet of the at least three ballistic specimens, and conducting, at the computing device, a cluster analysis based on the at least one similarity score and the at least one consistency measure to generate clusters of that at least three ballistic specimens.

### BRIEF DESCRIPTION OF THE DRAWINGS

Further features and advantages of embodiments described herein may become apparent from the following detailed description, taken in combination with the appended drawings, in which:

FIG. 1 is a schematic diagram of three example bullets A, B, and C that satisfy optimal toolmark alignment based on relative phase;

FIG. 2 is a schematic diagram of three example land engraved areas (LEAs) L4, L2 and L3, from example bullets A, B, and C of FIG. 1, that satisfy optimal toolmark alignment based on relative one-dimensional (1D)-translation;

FIG. 3 is a schematic diagram of three example cartridge cases A, B and C, which satisfy optimal toolmark alignment based on relative rotation for the breech face;

FIG. 4 is a flowchart of an example method for determining clustering based on similarity score and consistency of optimal toolmark alignment between three or more ballistic specimens;

FIG. 5 is a flowchart of an example method for determining clustering based on similarity measure between two or more ballistic specimens, following a standard hierarchical agglomerative clustering (HAC) algorithm;

FIGS. 6A and 6B illustrate a flowchart of an example method for determining clustering based on similarity score and consistency of optimal alignment of toolmark between three or more ballistic specimens, following a modified HAC algorithm;

FIG. 7 is an image of two example ballistic specimens, namely a non-deformed projectile and a fragmented projectile;

FIG. 8 is an image of an example ballistic specimen, showing the breech face and the firing pin of a cartridge case;

FIG. 9 is an image of example topographic data for the example ballistic specimens of FIG. 7;

FIG. 10 is an image of example topographic data of a cartridge case head stamp;

FIG. 11 is a schematic diagram of three example cartridge cases A, B and C, which satisfy optimal toolmark alignment based on relative rotation for the breech face and for the firing pin, where the latter has moved with respect to the breech face at different firings; and

FIG. 12 is a block diagram of an example computing device.

### DETAILED DESCRIPTION

A ballistic or toolmark identification analysis is generally performed to determine whether markings present on two or more specimens result from an interaction with a same tool. This task is traditionally performed by a trained firearm or toolmark examiner who visually compares pairs of specimens using an optical comparison microscope or using the more recently developed virtual comparison microscopy which relies on high precision surface topography capture and sophisticated computer image rendering. The training of a firearm or toolmark examiner consists in observing thousands of examples of common source pairs of markings (also referred to as “known matches” and different source pairs of markings (also referred to as “known non-matches”) for various type of firearms, tools, materials, etc. Through this training, the examiner builds a mental representation of the expected amount of similarities for matches and non-matches under various conditions against which he/she evaluates the current pair of toolmarks under evaluation.

No two toolmarks produced by the same tool are identical at the lateral and depth resolutions relevant for firearm identification. However, there are generally sufficient similarities between toolmarks associated with the same tool. Some example toolmarks for firearm identification of firearms are the breech face mark, firing pin mark, aperture shear marks, ejector mark, extractor mark and chamber mark on cartridge cases, and parallel striations on bullets. Most bullet markings unique to a given firearm are present on a small, ordered set of regions of interest (typically between 1 and 24), referred to herein as “land engraved areas” (LEAs), which are in contact with the barrel during firing.

Visual analysis of a pair of specimens, either with a conventional or a virtual comparison microscope, first consists in determining the relative position of the two specimens which optimizes the alignment of their respective toolmarks, thereby achieving what is referred to herein as an “optimal toolmark alignment”. The expert moves alternately one or the other of the specimens, where translational and/or rotational movements are possible for each ballistic specimen. The expert can also change the conditions under which the objects are compared, by modifying the focus, the intensity of the lighting or the type of light source. Once the optimal toolmark alignment has been determined, the expert evaluates whether the observed specimens meet sufficient agreement for a common source origin.

The operations just described become significantly more complex as the number of specimens under study increases. First, the number of distinct pairs to be analyzed under a comparison microscope increases approximately as the square of the number of specimens. In addition, it may be necessary: i) to find groups of potential matches or ii) to determine the most probable number of distinct firearms associated with the set of specimens, based on the pairwise similarities observed. However, similarity-based grouping is not always sufficient in practice, because uncertain cases (referred to as inconclusive) are frequently met and sometimes critical in firearm toolmark identification.

In some cases, a given pair of specimens that has been fired by the same firearm may still not fully meet sufficient agreement for a common source origin. This may happen for comparisons that involve at least one deformed or fragmented bullet. Cartridge cases can be challenging as well, especially if they are of different compositions. Inclusion of such an uncertain specimen within a previously found group of potential matches can be relevant if consistency of optimal toolmark alignment is satisfied for the resulting augmented group, that is, including the additional challenging specimen. As used herein, the term “consistency”, i.e. consistency of optimal toolmark alignment, thus implies that all members of a cluster can simultaneously be aligned by appropriately rotating and/or translating every specimen with respect to the others. This added step can be critical for case work if challenging specimens are found on a crime scene.

In the context where the number of specimens being compared is three or more, an additional criterion complements toolmark similarity. This criterion is inspired by the operations performed by the firearms expert who attempts to link more than two specimens using a physical or virtual comparison microscope. The expert must ensure consistency of optimal toolmark alignment for any group of three or more specimens that he or she has assumed (so far) to be matches based on pairwise comparison. Some of these groups may be broken if consistency of optimal toolmark alignment is not satisfied for some triplets of specimens. Similarly, some inconclusive specimens can be added to an existing group if consistency of optimal toolmark alignment is satisfied for the resulting group.

It is not possible to assess consistency of optimal toolmark alignment across several physical specimens on a comparison microscope since it only deals with two specimens at a time. However, this can be done on virtual microscopes that can simultaneously display the topography of more than two objects while allowing control of their respective position or orientation in space.

Automated ballistic identification systems can reproduce the previously described steps in principle, that is: image capture, search for optimal toolmark alignment in a pair comparison, computation of one or more pairwise similarity scores at optimal toolmark alignment, and similarity score-based clustering. Several methods and software packages provide at least one score S that quantifies toolmark similarity and standard score-based clustering can then be performed.

Assuming (for simplicity) that each pair comparison generates a unique similarity score S, the analysis of N specimens yields a symmetric score matrix of dimension N×N (whose diagonal element is irrelevant); it is assumed here that the score is invariant under the interchange of the first and second specimen of a compared pair. A standard score-based clustering method can then be applied to find groups (also referred to herein as “clusters”) of potential matches. For example, an agglomerative hierarchical clustering (HAC) algorithm builds a tree of cluster configurations, and a configuration can then be selected based on a suitable threshold.

Score-based clustering algorithms effectively support the expert's analysis when specimen pairs are clearly either from a common source or a different source. However, these algorithms cannot easily handle the most difficult specimens. In such cases, lowering the acceptance threshold involves merging clusters that would have been linked to different firearms, while increasing the threshold splits valid clusters. Additional information is therefore needed in the automated clustering process. This is provided by consistency of optimal toolmark alignment.

Search for optimal toolmark alignment of a pair of specimens is a necessary step for automated ballistic identification systems, as the capture of surface topography is usually performed at different times and locations (i.e., laboratories), by different users. Some degrees of freedom are thus unavoidable when positioning each specimen under the microscope or 3D sensor. Predefined centering or orientation protocols related to specimen positioning may have been defined. However, there is no guarantee that the images of potential matches will be perfectly aligned. Furthermore, it is sometimes impossible to define such a protocol. As an example, image capture of a pristine bullet can start from any point of its circumference, which generates a 360-degree band whose starting point is thus arbitrary. Any bullet comparison algorithm must therefore systematically search for the rotation (or translation along the band) of one specimen being compared with respect to the other in order to optimize toolmark alignment.

Similarly, planar rotations and translations are degrees of freedom for cartridge case images in principle. However, additional information can be used to constraint them, especially rotations. Depending on the marks present or on their microscopic structures, it is often possible to define a protocol for positioning the cartridge case during image capture. When parallel striations are present in the breech face mark, the cartridge case can be installed so that these striations are horizontal on the display. The degree of freedom that remains, an additional 180 degrees of planar rotation, can be applied based on a second mark whose position is used as a reference (e.g., the ejector mark on the headstamp, shear mark area of Glock cartridge cases or flowback mark) if present. It is more difficult to define an adequate protocol in the absence of a reference mark or preferential orientation of the striations in the breech face mark. Besides, the protocol problem remains if there is no human intervention. Such a fully automated system would capture cartridge cases in a random orientation in the absence of algorithms that automatically detect reference marks and determine their position.

More generally, the parameter space can include rotation, translations, and possibly scale factor, depending on the type of ballistic specimen. The optimal toolmark alignment parameters are therefore a result of any pairwise comparison algorithm, in addition to the similarity score.

Mathematically, the optimal toolmark alignment parameters across three specimens A-B-C are said to be consistent if the parameters of two pairs (e.g., A-B and B-C) predict those of the third pair (A-C). That is, the alignment parameters of the A-C pair are uniquely defined mathematical functions of the parameters of the A-B and B-C pairs. In practice, this strict definition is relaxed by allowing some uncertainty in the parameter values, considering measurement noise and expected topographic variations among common source specimens.

It is not intended that consistency of optimal toolmark alignment be used as the only criterion for grouping specimens. Indeed, it may happen, for example, that three cartridge cases A-B-C, of which only two were fired by the same firearm (e.g., A-B), do satisfy the criterion of consistency in terms of planar rotation. This is highly probable if all three cartridge cases show parallel striations. The comparison algorithm is likely to find that the relative orientations of the three pairs (A-B, B-C, and C-A) are consistent, even though cartridge case C does not resemble pair A-B, having been fired by another firearm. In such situations, consistency of optimal toolmark alignment is primarily determined by the class characteristics of the objects being compared, not by the uniqueness of the marks that characterize typical known matches. In this case, similarity scores are more relevant than consistency of toolmark alignment.

Consistency scores quantifying consistency of optimal toolmark alignment for groups of three specimens can be defined and used in cluster analysis in conjunction with a score-based clustering method. Four examples are discussed below, in which the consistency score of a triplet of specimens A-B-C is computed from the optimal alignment parameters of the A-B, B-C, and C-A pairs.

A first example will now be described. Each land of a firearm barrel is like a unique tool, independent of the other lands, leaving distinctive toolmarks, also referred to as land engraved areas (LEAs), on the fired bullet's surface. The comparison of two pristine bullets showing N LEAs (i.e., not fragments) leads to the possibility of N² LEA-to-LEA comparisons. However, since the sequence of the LEAs is fixed inside the barrel, these N² possibilities can be arranged into N groups, referred to as phases, of N LEA-to-LEA comparisons with consistent ordering. Finding the correct phase is usually the first step in bullet identification. The best phase satisfies the constraint: 0≤bestPhase≤(N−1).

An automated ballistic identification system determines the best phase of the compared pair in three steps. First, all LEA-to-LEA pairs are compared, which yields a matrix of N² scores. Next, N phase scores are computed based on the N scores associated to each phase. Finally, the best phase is defined as the phase associated with the largest phase score. Assuming N-LEA bullets, a best phase p implies that the matching LEA pairs (at the best phase) of the first and second member of each pair have index [0, p], [1, p+1], up to [N−1, (N−1+p) modulo N)], where the LEA indices are corrected by a modulo-N operation when needed.

Consider three bullets A, B and C, and let the best phase of the A-B pair and B-C pair found by the comparison algorithm be equal to p_{AB} and p_{BC}, respectively. Perfect consistency of the phase then requires that the best phase of the A-C pair is:

$$( {p}_{AB} + {p}_{BC} ) modulo N \qquad ( 1 )$$

More generally, perfect consistency of the best phase of a triplet of bullet specimens A-B-C is expressed mathematically as follows, with a consistency measure p_{ABC}:

$$( 2 )$$

$${p}_{AC} = ( {p}_{AB} + {p}_{BC} ) modulo N \to {p}_{ABC} ≡ ( {p}_{AB} + {p}_{BC} + {p}_{CA} ) modulo N ] = 0$$

where, as expected, the best phase between two bullets changes sign (modulo N) under the interchange of the first and second specimens. Only perfect consistency is allowed for the best phase. That is, the criterion for high consistency is:

$${p}_{ABC} = 0 \qquad ( 3 )$$

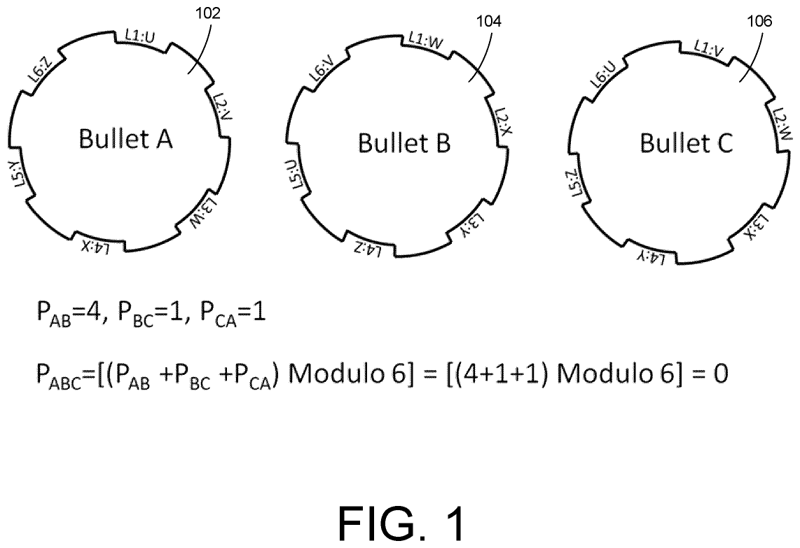

FIG. 1 illustrates an example with three 6-LEAs bullets, namely bullet A (labelled 102 in FIG. 1), bullet B (labelled 104 in FIG. 1), and bullet C (labelled 106 in FIG. 1), and their respective LEAs, L1 to L6, as defined by some users. Due to the freedom in selecting the first LEA, L1, the relative phase of the A-B, B-C, and C-A pair is 4, 1 and 1 respectively. Therefore, the three ordered sets of 6 LEAs L1-L6 do no correspond to the same 6 regions of interest of the firearm. For bullet A, the three ordered sets of 6 LEAs L1-L6 correspond to regions of interest (u, v, w, x, y, z); for bullet B, the three ordered sets of 6 LEAs L1-L6 correspond to (w, v, x, y, z, u) for bullet C, to (v, w, x, y, z, u). The criterion of high consistency is satisfied by this triplet.

A second example will now be described. As discussed above, the comparison of two pristine bullets showing N LEAs leads to the possibility of N² LEA-to-LEA comparisons. Each LEA-to-LEA comparison performed by the expert requires a systematic search for the best alignment of the toolmarks, i.e., fine rotational or translational displacements of one physical bullet relative to the other. Automated ballistic identification systems frequently convert the topographic image of a LEA into a 1D profile. Alternately, a straightening operation can be applied on every LEA image in order to realign the marks horizontally. Displacements performed by the expert then correspond to translations of the profile (or straightened image) with respect to the other.

For three bullet specimens, perfect consistency of optimal alignment of LEAs in terms of translation implies a vanishing consistency measure T_{ABC}:

$${T}_{ABC} ≡ \vert {T}_{AB} + {T}_{BC} + {T}_{CA} \vert = 0 \qquad ( 4 )$$

where the T_{AB}, T_{BC}, and T_{CA} are 1D displacements and | . . . | is the absolute value of its argument. A reasonable criterion for high consistency is therefore:

$${T}_{ABC} \leq ϵ \qquad ( 5 )$$

where a positive threshold ε is defined to allow small measurement errors or numerical errors when computing the profile or applying the straightening operation on the image from the original topographic data.

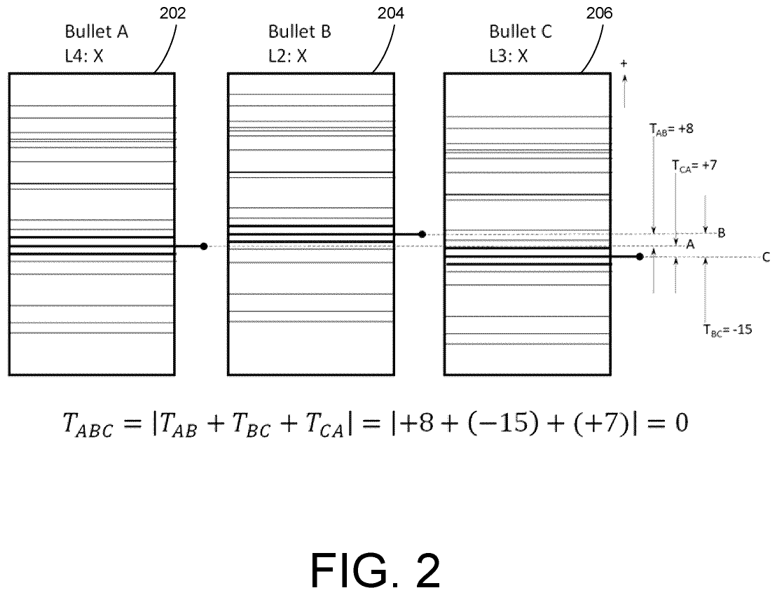

FIG. 2 illustrates an example with LEAs L4 (labelled 202 in FIG. 2), L2 (labelled 204 in FIG. 2), and L3 (labelled 206 in FIG. 2), of the three 6-LEAs bullets A, B, and C of FIG. 1. The three LEAs shown are associated with the same region of interest X of the firearm. Due to the freedom in selecting the exact location of the LEAs, the relative 1D (vertical) translation of the A-B, B-C, and C-A pair is +8, −15, and +7, in some arbitrary units, respectively. The criterion of high consistency is satisfied by this triplet.

A third example will now be described. Consider given regions of interest of the same type, for example the breech face mark, found on the head of three cartridge cases A, B and C. Let the optimal relative rotation angle of the A-B pair and B-C pair found by the comparison algorithm be +10 and +20 degrees, respectively. Perfect consistency then requires that the relative rotation angle of the A-C pair is +30 degrees.

More generally, perfect consistency of the optimal rotation of a triplet of specimens A-B-C is expressed mathematically as follows, with a consistency measure @ABC:

$${θ}_{AB} + {θ}_{BC} = {θ}_{AC} \to {θ}_{ABC} ≡ \vert {θ}_{AB} + {θ}_{BC} + {θ}_{CA} \vert = 0 \qquad ( 6 )$$

where it is assumed that the optimal relative rotation of two breech face images changes sign under the interchange of the first and second specimens of the pair, that is θ_{AC}=−θ_{CA}. It is obviously implied in the above mathematical equation that the 360-degree degeneracy is properly handled. A reasonable criterion for high consistency is therefore that the consistency measure be less than some sufficiently small threshold E:

$${Θ}_{ABC} \leq ϵ \qquad ( 7 )$$

which allows small measurement errors.

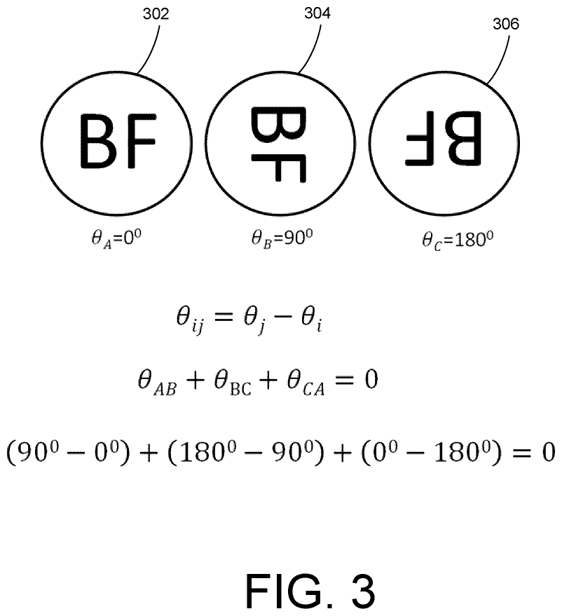

FIG. 3 illustrates an example with the respective breech faces 302, 304, 306 of three cartridge cases A, B, and C. Due to the freedom in defining the initial orientation of the cartridge case, the absolute rotation of the cartridge cases A, B and C (as defined with respect to the BF characters) is 0, 90 and 180 degrees respectively. Absolute angle has no meaning for several cartridge cases which have no arbitrary patterns with no preferred orientation. However, this example allows to define the relative rotation between the A-B, B-C, and C-A pairs (+90, +90, and −180 degrees, respectively) which can be found by a comparison algorithm. The criterion of high consistency is satisfied by this triplet.

A fourth example will now be described. Similarly to the previous example, consider the academic case of three breech face regions that are perfectly aligned rotationally during image capture, that is:

$${θ}_{AB} = {θ}_{BC} = {θ}_{CA} = 0 \qquad ( 8 )$$

Then perfect consistency of optimal toolmark alignment in terms of translation implies a vanishing consistency measure T_{ABC}:

$${T}_{ABC} ≡ \vert {T}_{AB} + {T}_{BC} + {T}_{CA} \vert = 0 \qquad ( 9 )$$

where the Ts are two-dimensional (2D) relative translations and the | . . . | symbol refers to the norm of its vector argument. A reasonable criterion for high consistency is then:

$${T}_{ABC} \leq ϵ \qquad ( 10 )$$

In all previous examples, a consistency (referred to herein as “triplet-wise consistency”) measure is defined for a single operation (phase, translation, or rotation). However, computation of consistency measures can be generalized for combinations of rotation, translation, scale factor, and phase (bullet), and applied in a clustering procedure based on consistency of optimal toolmark alignment. Such a clustering algorithm performs operations similar to those of standard score-based clustering algorithms but uses a 3-dimensional array of values that quantifies consistency at optimal toolmark alignment. Assuming (for simplicity) that each pair comparison yields a single similarity score S and a single consistency measure, the analysis of N specimens thus yields a N×N score matrix and a N×N×N array of consistency measures.

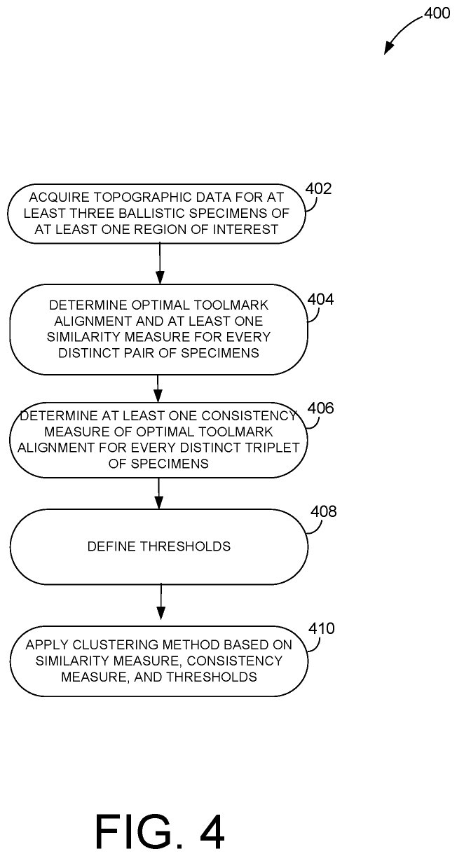

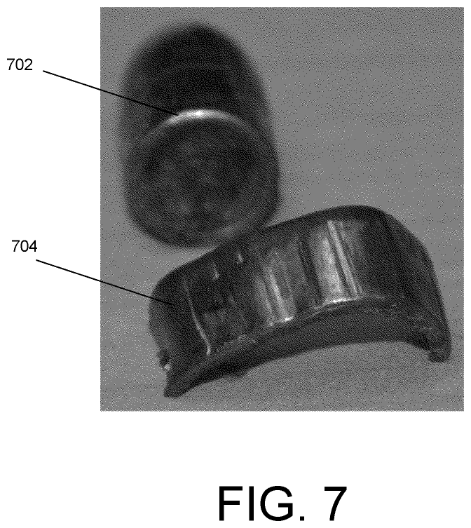

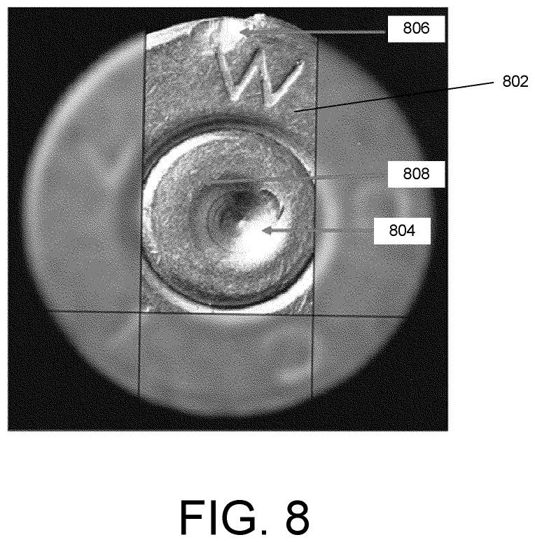

With reference to FIG. 4, there is illustrated an example method 400 for performing clustering based on similarity score and the consistency measure between at least three ballistic specimens of the same type. At step 402, topographic data is acquired for at least three ballistic specimens of at least one region of interest. Example ballistic specimens are illustrated in FIG. 7, namely a non-deformed bullet 702 and a deformed bullet 704, and in FIG. 8, namely a cartridge case head stamp 802 with a breech face 804, an ejector mark 806, and a firing pin 808.

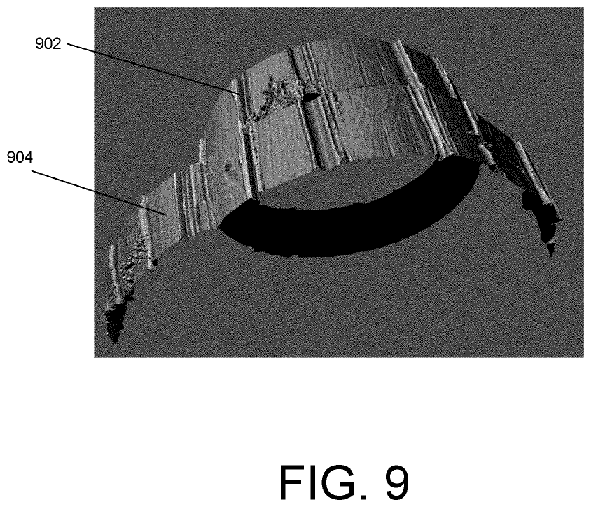

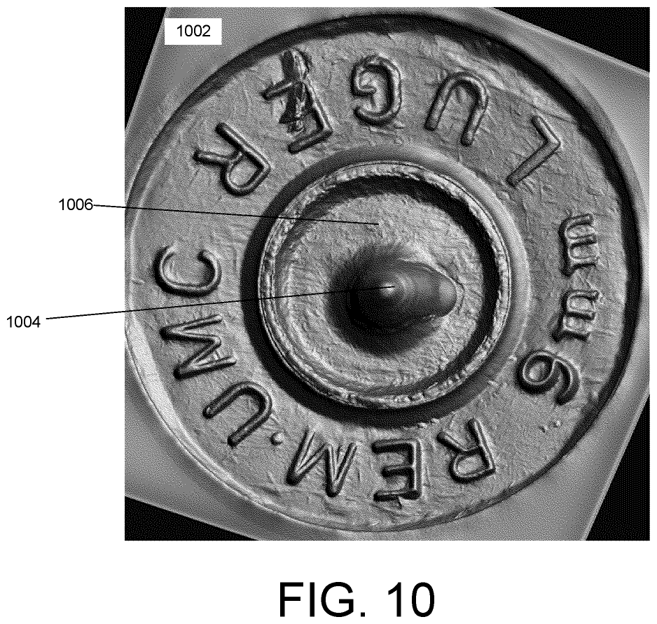

FIG. 9 illustrates an example of topographic data 902, 904 for the non-deformed bullet 702 and deformed bullet 704 of FIG. 7, respectively. The topographic data 902, 904 may take various forms, including, but not limited to, a 3D map of the surface of the specimen, a 2D map of the surface of the specimen (i.e. without shape information of the specimen, also referred to as a “roughness image”), a reflectance image, and the like. The topographic data 902, 904 may be acquired using an image acquisition tool, such as a high resolution microscope, a high resolution 3D sensor, and the like. In some embodiments, the measured topography is converted into a profile by averaging the areal topographic measurements along the main orientation of the striations, thus reducing the contribution of the instrumental noise and smoothing out the random fluctuations of the bullet topography at very small depth scales which are irrelevant for firearm identification. FIG. 10 illustrates an example of topographic data for a cartridge case head 1002, with firing pin mark 1004 and a breech face mark 1006.

Referring back to FIG. 4, at step 404 optimal toolmark alignment and at least one similarity measure (also referred to herein as a “similarity score”) are determined for each distinct pair of specimens, from the topographic data acquired at step 402. Optimal toolmark alignment for each pair is described by at least one value, which represents relative rotation, translation, phase (for bullets), and/or scale factor.

As will be discussed below, the consistency of the optimal toolmark alignment can be expressed with linear operators, and perfect consistency of three samples A-B-C means that the product of the three specific operators yields the identity operator. A non-negative consistency measure Δ can then be defined by some distance between the resulting product of operators and the identity operator. This abstract definition is concretized by expressing the operators as affine transformation matrices (associated to pairs A-B, B-C, and C-A, respectively), defining a matrix M as the product of the three matrices as follows:

$$M = {M}_{AB} {M}_{BC} {M}_{CA} \qquad ( 11 )$$

and computing the squared Frobenius norm of the matrix difference, as follows:

$$Δ ≡ {\vert {M}_{} - I \vert}^{2} = {\sum }_{i , j = 1}^{N} {( {M}_{ij} - {I}_{ij} )}^{2} \qquad ( 12 )$$

where I is the identity matrix, with Iⱼ equal to 1 if i=j, and 0 otherwise.

This methodology is discussed in detail below for the following scenarios: 2D rotation, 2D translation, and a combination of rotation and translation for cartridges; 1D translation, and a combination of 1D translation and scale factor for bullet profiles. In two of these scenarios, the elements of the operator's matrix representation do not have the same units, and consistency is expressed using two separate measures that only involve matrix elements with the same units. Bullet phase consistency analysis can also be accomplished with matrix operators as described, as an alternative to the method described above.

A first scenario, namely 2D rotation consistency, with a region of interest of the same type on cartridge cases, will now be described. In this scenario, consistency implies that

$${M}_{ABC} ≡ {M}_{AB} {M}_{BC} {M}_{CA} = I \qquad ( 13 )$$

where M_{AB}, M_{BC} and M_{CA} are standard 2D rotation matrices associated with the respective relative rotation angle of the distinct pairs θ_{AB}, θ_{BC} and θ_{CA}, respectively. Their product necessarily yields a new rotation matrix, thus of the form:

$${M}_{ABC} = ( \begin{matrix}c & - s \\ s & c\end{matrix} ) \qquad ( 14 )$$

where c and s are the cosine and sine of an angle, respectively.

A suitable distance measure is the square norm difference of MABC and the identity matrix:

$${\vert {M}_{ABC} - I \vert}^{2} = 4 ( 1 - c ) \qquad ( 15 )$$

Any increasing function of the above expression (from equation (15)) can be defined as the consistency score, the simplest being:

$${ΔΘ}_{ABC} = ( 1 - c ) \qquad ( 16 )$$

A threshold can then be defined on this quantity for clustering application. Ambiguity with multiples of 2π (or 360 degrees) is automatically managed by this matrix formalism.

A second scenario, namely 2D translation consistency, with a region of the same type on cartridge cases, will now be described. The same methodology is applicable to images of cartridge case's head. The academic case in which three cartridge case images are rotationally aligned is first considered. The degrees of freedom are 2D translations, and the translation operator is expressed with the augmented matrix:

$$M = ( \begin{matrix}1 & 0 & {Δ}_{X} \\ 0 & 1 & {Δ}_{Y} \\ 0 & 0 & 1\end{matrix} ) \qquad ( 17 )$$

which requires that all vectors be augmented with a “1” with no units at the end. Translations in the X-Y plane are properly handled as follows:

$$M ( \begin{matrix}X \\ Y \\ 1\end{matrix} ) = ( \begin{matrix}X + {Δ}_{X} \\ Y + {Δ}_{Y} \\ 1\end{matrix} ) \qquad ( 18 )$$

The product of the three augmented matrices M_{AB}, M_{BC}, and M_{CA} for associated to the A-B, B-C and C-A pairs keeps the same form:

$${M}_{ABC} = ( \begin{matrix}1 & 0 & {T}_{X} \\ 0 & 1 & {T}_{Y} \\ 0 & 0 & 1\end{matrix} ) \qquad ( 19 )$$

A suitable distance measure is the square norm difference of MABC and the identity matrix:

$${\vert {M}_{ABC} - I \vert}^{2} = {T}_{X}^{2} + {T}_{Y}^{2} \qquad ( 20 )$$

Any increasing function of the above expression (from equation (20)) can be defined as the consistency score, the most natural being:

$$Δ {T}_{ABC} = \sqrt{{T}_{X}^{2} + {T}_{Y}^{2}} \qquad ( 21 )$$

This consistency score is a rotation-invariant consistency measure of relative translation.

A third scenario, namely rotation and 2D translation, with a region of interest of the same type on cartridge cases, will now be described. For real case work, it is necessary to consider simultaneous consistency of rotation and translation because cartridge cases are not generally imaged with a common orientation. Generalizing the previous example, the combination of 2D rotation and translation is also expressed with an augmented matrix:

$${M}_{} = ( \begin{matrix}{c}^{′} & - {s}^{′} & {Δ}_{X} \\ {s}^{′} & {c}^{′} & {Δ}_{Y} \\ 0 & 0 & 1\end{matrix} ) \qquad ( 22 )$$

which yields proper rotation and translation in the X-Y plane:

$$M ( \begin{matrix}X \\ Y \\ 1\end{matrix} ) = ( \begin{matrix}{c}^{′} X + {s}^{′} Y + {Δ}_{X} \\ {s}^{′} X + {c}^{′} Y + {Δ}_{Y} \\ 1\end{matrix} ) \qquad ( 23 )$$

The product of three matrices of this form for A-B, B-C and C-A pairs keeps the same form:

$${M}_{ABC} = ( \begin{matrix}c & - s & {T}_{X} \\ s & c & {T}_{Y} \\ 0 & 0 & 1\end{matrix} ) \qquad ( 24 )$$

where T_{X} and T_{Y} are functions of the three sets of matrix elements.

A single consistency measure cannot be defined in this case as trigonometric functions and translations are not comparable quantities, having different units. Indeed, since perfect consistency implies that:

$${\vert {M}_{ABC} - I \vert}^{2} = 4 ( 1 - c ) + {T}_{X}^{2} + {T}_{Y}^{2} = 0 \qquad ( 25 )$$

$$\to ( 1 - c ) = 0 and {T}_{X}^{2} + {T}_{Y}^{2} = 0 \qquad ( 26 )$$

Two consistency measures can be defined, one for the angle and the other for the translation:

$$Δ {T}_{ABC} = \sqrt{{T}_{X}^{2} + {T}_{Y}^{2}} \qquad ( 27 )$$

$${ΔΘ}_{ABC} = ( 1 - c ) \qquad ( 28 )$$

respectively.

A fourth scenario, namely 1D translation consistency, for a bullet, will now be described. The matrix method can be applied for consistency based on 1D translations for bullet profiles (or vertical translation of a straightened bullet image), in a similar manner to 2D translation consistency.

The product of the three augmented matrices M_{AB}, M_{BC}, and M_{CA} for the ABC triplet gives a matrix of the same form:

$${M}_{ABC} = ( \begin{matrix}1 & T \\ 0 & 1\end{matrix} ) \qquad ( 29 )$$

A suitable distance measure is the square norm difference of MABC and the identity matrix:

$${\vert {M}_{ABC} - I \vert}^{2} = {T}^{2} \qquad ( 30 )$$

Any increasing function of the above expression (from equation (30)) can be defined as the consistency score, the most natural being:

$$Δ {T}_{ABC} = \vert T \vert \qquad ( 31 )$$

A fifth scenario, namely 1D translation and scale consistency, for a bullet, will now be described. The above result (from the fourth scenario) can be generalized for combinations of relative translation and scale factor. The relative scale factor is a relevant parameter for bullets, which can expand unpredictably after shooting. The scale factor is unity when no uniform dilation or contraction operation is applied on any bullet profiles or images.

The translation operator and scale operations are expressed with the matrix:

$${M}_{} = ( \begin{matrix}{s}^{′} & {T}^{′} \\ 0 & 1\end{matrix} ) \qquad ( 32 )$$

The product of the three such matrices M_{AB}, M_{BC}, and M_{CA} for the ABC triplet gives a matrix of the form:

$${M}_{ABC} = ( \begin{matrix}s & T \\ 0 & 1\end{matrix} ) \qquad ( 33 )$$

where T is a function of the s and T matrix elements of the three matrices.

A single consistency measure cannot be defined as the scale factor and the translation are not comparable quantities, having different units. However, since perfect consistency implies that:

$${\vert {M}_{ABC} - I \vert}^{2} = {( s - 1 )}^{2} + {T}^{2} = 0 \qquad ( 34 )$$

$$\to s = 1 and \vert T \vert = 0 \qquad ( 35 )$$

two consistency scores can be defined as follows:

$$Δ {S}_{ABC} = \vert s - 1 \vert \qquad ( 36 )$$

$$Δ {T}_{ABC} = \vert T \vert \qquad ( 37 )$$

A sixth scenario, namely phase for a bullet, will now be described. Consider three N-LEA bullets A, B and C, and let the best phase of the three possible pairs found by the comparison algorithm be equal to p_{AB}, p_{BC} and p_{CA}, respectively. An abstract angle, referred to herein as a “phase angle”, can be defined for each phase as follows:

$${p}_{AB} \to {θ}_{AB} = 2 π \frac{{p}_{AB}}{N} \qquad ( 38 )$$

and similarly for the other pairs. This angle does not represent a real physical rotation and is rather a mathematical trick to apply the matrix formalism.

Perfect phase consistency implies that:

$${M}_{ABC} ≡ {M}_{AB} {M}_{BC} {M}_{CA} = I \qquad ( 39 )$$

where M_{AB}, M_{BC} and M_{CA} are 2D rotation matrices associated to the respective phase angles of the distinct pairs: θ_{AB}, θ_{BC} and θ_{CA}, respectively. The product of the three rotation matrices necessarily yields a new matrix of the same form:

$${M}_{A B C} = ( \begin{matrix}c & - s \\ s & c\end{matrix} ) \qquad ( 40 )$$

where c and s are the cosine and sine of an angle. A suitable phase consistency measure is:

$$Δ {P}_{A B C} = ( 1 - c ) \qquad ( 41 )$$

The only acceptable threshold for clustering based on phase consistency is 0 as a different phase is not allowed in a cluster.

Several standard clustering algorithms based on a proximity matrix are available. The proximity matrix encodes either similarities or dissimilarities between pairs of objects. The Hierarchical Agglomerative Clustering (HAC) algorithm, will now be described as a reference for later discussions. Since this algorithm is generally implemented in terms of dissimilarities, it will be assumed that the set of similarity scores s(a,b) (which encode similarity between pairs of ballistic specimens (a,b)) are converted into dissimilarity values d(a,b) by means of a suitable monotone-decreasing function. The latter values are stored in a symmetric matrix D. The modifications made to include the contribution of consistency of toolmark alignment will be discussed further below.

The HAC algorithm is iterative. This algorithm builds a hierarchy of cluster configurations parameterized by a hierarchical index. Assuming there are N specimens, each one initially forms a singleton cluster, that is, a cluster of one element. At each iteration, the closest two clusters are merged into a single cluster, and the number of clusters therefore decreases by one unit. At the last iteration, all elements belong to the same, unique cluster. This process assumes that the inter-cluster distance d (A,B) between pairs of disjoint clusters (A, B) has been suitably defined based on the D matrix. Once the whole hierarchy of clusters is determined, a particular configuration of clusters can be selected by choosing a hierarchical index.

The inter-cluster distance d (A,B) is generally a function of the set of distances d (a,b) where elements a and b belong to clusters A and B, respectively. Several such functions, collectively denoted as linkage methods, are well known to those skilled to the art, the mostly used being Complete Linkage, Single Linkage, and Group Average.

Complete Linkage is defined as follows:

$$d ( A , B ) = {Max}_{Ω} ( d ( a , b ) ) , Ω ≡ \{ ( a , b ) \vert a ∈ A , b ∈ B \} \qquad ( 42 )$$

Single Linkage is defined as follows:

$$d ( A , B ) = {Min}_{Ω} ( d ( a , b ) ) , , Ω ≡ \{ ( a , b ) \vert a ∈ A , b ∈ B \} \qquad ( 43 )$$

and Group Average is defined as follows:

$$d ( A , B ) = {Mean}_{Ω} ( d ( a , b ) ) , , Ω ≡ \{ ( a , b ) \vert a ∈ A , b ∈ B \} \qquad ( 44 )$$

Single Linkage defines the distance between two clusters as the distance between their two closest elements (one in each cluster). Complete Linkage rather chooses the distance between the two farthest elements, while Group Average represents a compromise between these two extremes. Complete Linkage leads to more compact clusters.

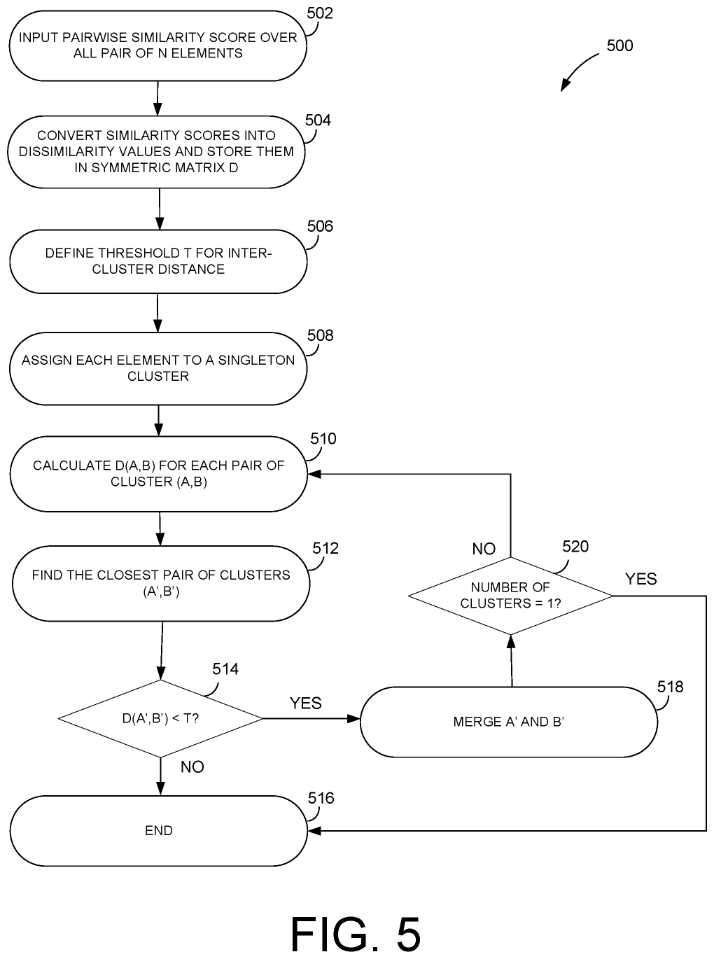

FIG. 5 shows an example method 500, which is a slightly modified version of the standard HAC algorithm, in which the iterative process stops when a threshold-based criterion is satisfied. This truncated version of the algorithm is suitable for a direct comparison with the proposed generalized algorithm discussed herein below. The input of the algorithm is a set of similarity scores over all pairs of N elements provided at step 502. The similarity scores input at step 502 are converted to appropriate dissimilarity values and stored in a symmetric (N×N) matrix D at step 504. A threshold T for the inter-cluster distance is then defined in step 506.

In an initialization step 508, each specimen is assigned to a singleton cluster. A loop (steps 510 to 520) is then executed over a hierarchical index. The inter-cluster distance d (A,B) is first calculated for each pair of clusters (A, B) with a given linkage method at step 510. The closest pair of clusters (A′, B′) is then found at step 512. The next step 514 is to compare the distance D(A′, B′) of the two closest clusters to the threshold T. If it is determined at step 514 that the distance of the two closest clusters is larger than (or equal to) the threshold T, the method 500 ends at step 516. Otherwise, if it is determined at step 514 that the distance of the two closest clusters is smaller than the threshold T, these two clusters A′ and B′ are merged into one cluster at step 518. The next step 520 is then to assess whether the number of clusters is equal to one. If this is the case, i.e. there is only one cluster, the method 500 ends at step 516. Otherwise, if the number of clusters is not equal to (i.e. is greater than) one, the method 500 returns to step 510 and the iterative process continues (i.e. steps 510 to 520 are repeated), which may lead to additional cluster merging operations. At the end of the iterative process (i.e. at step 516), the last cluster configuration satisfies the threshold-based criteria.

Traditional clustering methods based on a dissimilarity matrix can be generalized to further include consistency of toolmark alignment measures defined herein above. The D matrix of dissimilarity values is now complemented by 3D arrays A of consistency values. There is one such array per type of consistency score (associated to rotation, translation, phase or scaling) in the context of optimal toolmark alignment.

In contrast to similarity scores, the consistency measures defined previously already quantify dissimilarity or distance, i.e., their value increases as the level of dissimilarity (or disagreement) increases. Hence, consistency values do not require any functional transformation as it was the case for similarity scores.

A consistency threshold Tc and a linkage strategy are required for each type of consistency measure. The inter-cluster consistency measure Δ(A,B) between two disjoint clusters A and B can be defined by linkage methods which are functions of the set of consistent measures Δ(a,b,c) between triplet of elements (a,b,c), two of which belong to one of the clusters, the third one being a member of the other cluster. These are two examples, that can be defined as complete linkage and single linkage, respectively, for consistency measures:

$$Δ ( A , B ) = {Max}_{Ω} ( Δ ( a , b , c ) ) , Ω ≡ \{ ( a , b , c ) \vert a ∈ A , b ∈ B , c ∈ ( A ⋃ B ) \} \qquad ( 45 )$$

$$Δ ( A , B ) = {Min}_{Ω} ( Δ ( a , b , c ) ) , Ω ≡ \{ ( a , b , c ) \vert a ∈ A , b ∈ B , c ∈ ( A ⋃ B ) \} \qquad ( 46 )$$

In the context of ballistic toolmark analysis, a clustering method based on similarity and consistency of toolmark alignment must handle three situations that will be described further below.

First, in a given set of N specimens, it may be found that a pair (a,b) sharing a high level of similarity does not satisfy the consistency criterion with any other specimen c in the set. Therefore, an acceptance/rejection criterion must be defined for such a pair of items, which can potentially form a two-item cluster in the final configuration of clusters. Such a cluster is considered valid if the dissimilarity d (a,b) is less than a predetermined pair-distance threshold Tp. Triplet-wise consistency of toolmark plays no role here.

Second, in a set of N specimens, a triplet of distinct specimens (a,b,c) satisfying consistency of toolmark alignment must be a valid cluster if the dissimilarity level of the set, d (a,b,c), is less than a second threshold referred to herein as the group-distance threshold, Tg. The allowed level of dissimilarity sought must be higher than that of the pair discussed in the previous scenario, i.e., Tg>Tp. This strategy allows to create clusters of more than two elements while being less strict on the similarity criterion if the consistency criterion is satisfied. This strategy thus answers one of the technical problems at the heart of the methods and systems proposed herein, namely to facilitate the grouping of specimens whose level of similarity is lower, provided that consistency of toolmark alignment is satisfied.

Third, it is observed that the concept of optimal alignment is meaningless if the level of similarity is too low for a given pair of specimens. Low similarity implies that any displacement (rotation, translation, etc.) of one specimen with respect to the other leads to equally poor alignment. This in turn implies that the consistency of a triplet (a, b, c) is rarely satisfied as soon as one of its three possible pairs ((a,b), (a,c) or (b,c)) obtains a low similarity score, even for known matches. It is therefore desirable for a suitable clustering algorithm to handle two opposite tendencies: 1) exploiting the concept of consistency of toolmark alignment even if the level of similarity is not optimal; 2) the concept of optimal toolmark alignment is meaningless when the level of similarity is very low.

A concrete case illustrates the problem. A specimen z is considered in the merging process with a cluster A of three elements (a,b,c) which satisfy the dissimilarity and consistency criteria. Moreover, the dissimilarity level of the z with the elements of A satisfies:

$$d ( a , z ) \leq {T}_{g} , d ( b , z ) \leq {T}_{g} , but d ( c , z ) > {T}_{g} \qquad ( 47 )$$

In the absence of a consistency criterion, some linkage methods would allow to create a cluster with these four elements with an acceptance threshold Tg, even if d(c,z)>Tg. For example, single linkage allows this merging process since:

$$d ( \{ a , b , c \} , \{ z \} ) = {Min}_{y ∈ A} ( d ( y , z ) ) \leq {T}_{g} \qquad ( 48 )$$

while complete linkage does not:

$$d ( \{ a , b , c \} , \{ z \} ) = {Max}_{y ∈ A} ( d ( y , z ) ) > {T}_{g} \qquad ( 49 )$$

It will now be assumed that Single linkage is used, and the element z could be merged with cluster A, based on dissimilarity only. The last criterion that remains to be evaluated is consistency of toolmark alignment. The values of interest are Δ(a,b,z), Δ(a,c,z) and Δ(b,c,z), that must be compared with the consistency threshold Tc.

A case that requires special analysis is one for which Δ(a,b,z)<Tc while Δ(a,c,z) and Δ(b,c,z)>Tc. Thus, the only triplet that satisfies the consistency criterion includes the elements a and b, which both satisfy the distance criterion with z(d(a,z) and d(b,z)<Tg). The other two triplets do not satisfy the consistency criterion, and moreover include the pair (c,z) which does not satisfy the similarity criterion. It is possible to modify the linkage of the consistency measure to discard pairs with low similarity, for which optimal alignment is meaningless. Complete Linkage can be modified as follows:

$$Δ ( A , B ) = {Max}_{Ω} ( Δ ( a , b , c ) ) \qquad ( 50 )$$

where:

$$Ω ≡ \{ ( a , b , c ) \vert a ∈ A , b ∈ B , c ∈ ( A ⋃ B ) , AND Max ( d ( a , b ) , d ( a , c ) , d ( b , c ) ) \leq {T}_{g} \} \qquad ( 51 )$$

The simultaneous use of two types of measures (dissimilarity score and parameters of optimal alignment of toolmark) thus provides new options for linkage functions. These can exploit the fact that the two types of variables are not independent. In particular, pairs of specimens with low similarity, that is with a dissimilarity larger than the group-distance threshold Tg, can be discarded from the computation of the inter-cluster consistency measures.

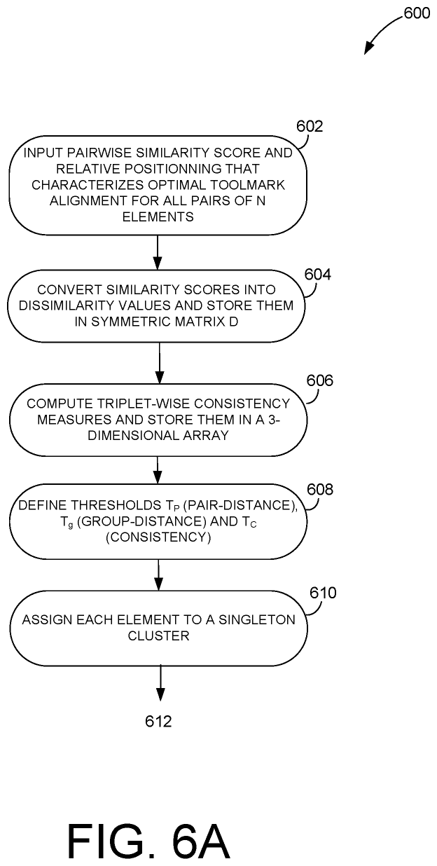

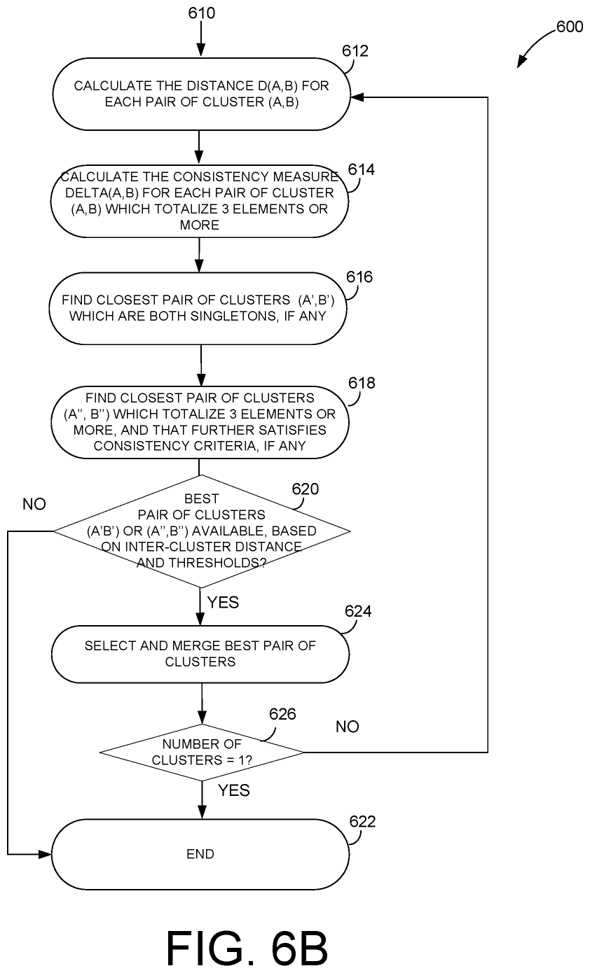

FIGS. 6A and 6B illustrate an example method 600, generalization of the standard hierarchical clustering algorithm, which is relevant for the methods and systems proposed herein. Only one consistency measure is assumed in this example, but the method 600 can be extended to consider several types of consistency measures (for example relative rotation and translation for cartridge cases or phase and translation for bullets). The input of the algorithm is provided at step 602 and is two-fold for each pair of N elements: a similarity score and a parameter that characterizes relative positioning of the compared pair at optimal toolmark alignment. The similarity scores are converted to appropriate dissimilarities and stored in a symmetric (N×N) matrix D in step 604. The triplet-wise consistency scores over all triplets of N specimens are computed and stored in a 3D (N×N×N) array A, respectively, at step 606.

Three thresholds are then defined at step 608: the pair-distance threshold Tp, the group-distance threshold Tg and the consistency threshold Tc. As previously discussed, the pair-distance threshold is used to validate merging of two singletons, while the group-distance threshold is applied for a pair of clusters which, together, includes more than two elements, and which furthermore satisfies consistency of toolmark alignment. At initialization (step 610), each of the N specimens initially forms (i.e. is assigned to) a singleton cluster. A loop (steps 612 to 626 in FIG. 6B) is then executed over an integer index, the hierarchical level.

As illustrated in FIG. 6B, the inter-cluster distance D(A,B) is computed for each cluster pair (A,B) at step 612. A linkage method is used when both A and B are not singleton. Similarly, the consistency measure Δ(A,B) is computed at step 614 for each pair of cluster (A, B) which totalize three elements of more, i.e. when the combined number of elements of A and B is three or more. A linkage method is used here as well when more than three elements are involved. The closest pair (A′, B′) of singletons (if any) is found in step 616. Similarly, the closest pair of clusters (A″,B″), if any, which totalize (i.e. sum up to) three elements or more, and which further satisfy the consistency criteria is found in step 618. The next step 620 is then to determine whether a best pair of clusters, either (A′,B′) or (A″,B″), is available, based on their inter-cluster distance and thresholds. If no such pair is available, the iterative process ends at step 622. Otherwise, the best pair of clusters (A′, B′) or (A″, B″) is selected and the best two clusters are merged into one cluster at step 624. The next step 626 is then to assess whether the number of clusters is equal to one. If it is determined at step 626 that the number of clusters is unity, the process ends at step 622. Otherwise, the method 600 returns to step 612 and the iterative process continues (i.e. steps 612 to 626 are repeated), which leads to an additional cluster merging.

As the hierarchical level increases, the level of dissimilarity associated with the nearest pair of clusters may become larger than the pair-distance threshold Tp. At this point, it is no longer possible to merge two singles into a two-element cluster. However, clusters of more than two elements can still be created if their level of dissimilarity is less than the group-distance threshold Tg and if their consistency measure is less (or equal) than Tc.

At the end of the iterative process (steps 612 to 626 of FIG. 6B), the relevant cluster configuration is that created at the last iteration. This strategy allows creation of clusters which are either pairs with a distance smaller than the pair-distance threshold, or larger groups with a group distance smaller than the group-distance threshold, which furthermore satisfies consistency of optimal toolmark alignment.

The full use case is presented in FIG. 4, assuming a single consistency score is available per triplet of specimens. This second condition occurs for marks on cartridge cases (relative rotation only) and for bullets (phase only). The method 400 can be generalized for more than one type of consistency scores.

Referring back to FIG. 4, one pairwise similarity score is computed and optimal toolmark alignment is found for every pair of specimens at step 404, based on topographic data captured at step 402. In this example, optimal alignment is defined by a single alignment parameter, that can be rotation, translation or phase. At least one consistency measure (also referred to herein as a “consistency score”) indicative of optimal toolmark alignment is determined for every distinct triplet of specimens at step 406. Three acceptable thresholds for clustering (e.g., a pair-distance threshold, a group-distance threshold, and a consistency threshold) are defined at step 408. A clustering method based on the matrix of similarity scores (i.e. the similarity measure determined at step 404), a 3-dimensional array of consistency scores (i.e. the consistency measure determined at step 406), and the three thresholds (determined at step 408) is performed at step 410. In some embodiments, the clustering method is a HAC algorithm, which is generalized for triplet-wise consistency score, two between-cluster distance thresholds, and a consistency threshold, as described above with reference to FIGS. 6A and 6B. The final cluster configurations satisfy the three selected threshold values.

Optimal toolmark alignment analysis and its use to clustering also applies to relative optimal alignment between toolmarks of different types that are simultaneously present on a triplet of cartridge cases. Consider the breech face and firing pin marks present on cartridge cases A, B, and C. Search for optimal toolmark alignment for the three pairs A-B, B-C and C-A generates the following 6 angles: θ_{AB}^{BF}, θ_{BC}^{BF}, θ_{CA}^{BF}, θ_{CA}^{BF}, θ_{AB}FP, θ_{BC}^{FP}, θ_{CA}^{FP}.

The relative orientation difference of the breech face and firing pin marks can then be defined as follows, for each pair:

$${θ}_{A B}^{B F - F P} ≡ {θ}_{A B}^{B F} - {θ}_{A B}^{F P} \qquad ( 52 )$$

$${θ}_{B C}^{B F - F P} ≡ {θ}_{B C}^{B F} - {θ}_{B C}^{F P} \qquad ( 53 )$$

$${θ}_{C A}^{B F - F P} ≡ {θ}_{C A}^{B F} - {θ}_{C A}^{F P} \qquad ( 54 )$$

The condition for perfect consistency (in terms of rotation) for these two marks is, as discussed previously:

$${θ}_{A B}^{B F} + {θ}_{B C}^{B F} + {θ}_{C A}^{B F} = 0 \qquad ( 55 )$$

$${θ}_{A B}^{F P} + {θ}_{B C}^{F P} + {θ}_{C A}^{F P} = 0 \qquad ( 56 )$$

The difference between these two expressions yields the expression for perfect consistency of the relative toolmark alignment for the breech face and firing pin:

$${θ}_{A B C}^{B F - F P} ≡ \vert {θ}_{A B}^{B F - F P} + {θ}_{BC}^{B F - F P} + {θ}_{CA}^{B F - F P} \vert = 0 \qquad ( 57 )$$

It can be shown that this expression remains valid if one mark moves relative to the other during different firings. This situation is encountered in practice with certain types of firearms where the firing pin has some freedom of movement in the barrel. This implies that the relative position of the firing pin mark in relation to the breech face mark can vary on a set of cartridge cases fired by the same firearm. This phenomenon is correctly managed by the consistency measure.

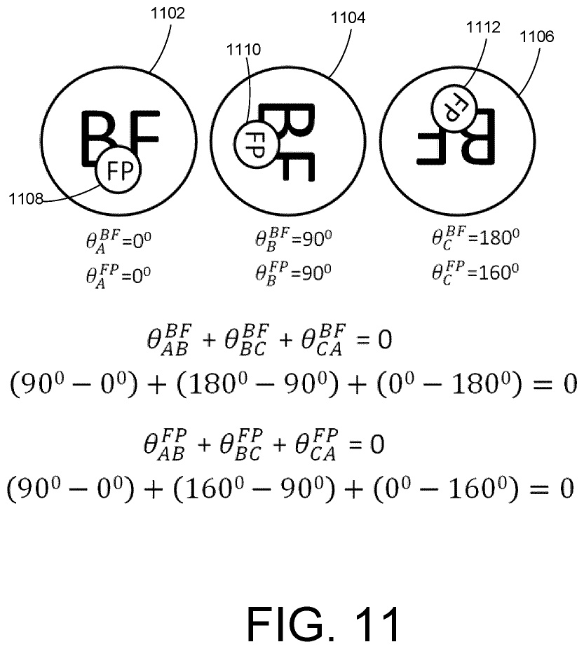

FIG. 11 illustrates an example with the respective breech faces 1102, 1104, 1106 and the respective firing pins 1108, 1110, 1112 of three cartridge cases A, B, and C. Due to the freedom in defining the initial orientation of the specimens, the absolute rotation of the cartridge cases A, B and C (as defined with respect to the BF characters in each breech face 1102, 1104, or 1106) is 0, 90 and 180 degrees, respectively. Furthermore, since the firing pin 1108, 1110, or 1112 is free to move with respect to the breech face 1102, 1104, or 1106, the corresponding angles are 0, 90 and 160 for the firing pin 1108, 1110, or 1112. This example allows to define the relative rotation between the A-B, B-C, and C-A pairs (as it would be found by an algorithm) to be +90, +90, and −180 degrees, respectively, for the breech face 1102, 1104, or 1106, and +90, +70, and −160 degrees, respectively, for the firing pin 1108, 1110, or 1112. As shown, the criterion for high consistency is satisfied independently for the breech face 1102, 1104, or 1106 and the firing pin 1108, 1110, or 1112.

Furthermore, the relative positioning of the two marks can be defined as follows:

$${θ}_{A B}^{B F - F P} ≡ {θ}_{A B}^{B F} - {θ}_{A B}^{F P} = ( 90 - 90 ) = 0 \qquad ( 58 )$$

$${θ}_{B C}^{B F - F P} ≡ {θ}_{B C}^{B F} - {θ}_{B C}^{F P} = ( 90 - 70 ) = 20 \qquad ( 59 )$$

$${θ}_{C A}^{B F - F P} ≡ {θ}_{C A}^{B F} - {θ}_{C A}^{F P} = ( - 180 + 160 ) = - 20 \qquad ( 60 )$$

The criterion for high consistency of the relative orientation of two types of marks is satisfied.

It can be shown that a similar reasoning is valid for 2D translation, and for a combination of rotation and 2D translation of cartridge case marks.

Clustering based on consistency of the relative position of marks of two different types can thus be implemented with the method previously described, that is, using matrix operations and suitable thresholds.

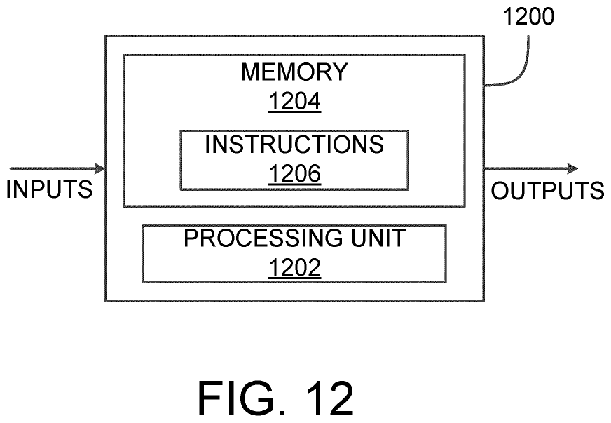

In some embodiments, the methods 400, 500, and 600 described herein above are implemented in one or more computing device 1200, as illustrated in FIG. 12. For simplicity only one computing device 1200 is shown but more computing devices 1200 operable to exchange data may be included. The computing devices 1200 may be the same or different types of devices.

The computing device 1200 comprises a processing unit 1202 and a memory 1204 which has stored therein computer-executable instructions 1206. The processing unit 1202 may comprise any suitable devices configured to implement the methods 400, 500, 600 such that instructions 1206, when executed by the computing device 1200 or other programmable apparatus, may cause the functions/acts/steps performed as part of the methods 400, 500, 600 to be executed. The processing unit 1202 may comprise, for example, any type of general-purpose microprocessor or microcontroller, a digital signal processing (DSP) processor, a central processing unit (CPU), an integrated circuit, a field programmable gate array (FPGA), a reconfigurable processor, other suitably programmed or programmable logic circuits, or any combination thereof.

The memory 1204 may comprise any suitable known or other machine-readable storage medium. The memory 1204 may comprise non-transitory computer readable storage medium, for example, but not limited to, an electronic, magnetic, optical, electromagnetic, infrared, or semiconductor system, apparatus, or device, or any suitable combination of the foregoing. The memory 1204 may include a suitable combination of any type of computer memory that is located either internally or externally to device, for example random-access memory (RAM), read-only memory (ROM), compact disc read-only memory (CDROM), electro-optical memory, magneto-optical memory, erasable programmable read-only memory (EPROM), and electrically-erasable programmable read-only memory (EEPROM), Ferroelectric RAM (FRAM) or the like. Memory 1204 may comprise any storage means (e.g., devices) suitable for retrievably storing machine-readable instructions 1206 executable by processing unit 1202.

The methods 400, 500, 600 for determining a cluster configuration based on pairwise similarity measure and triplet-wise consistency measures as described herein may be implemented in a high-level procedural or object-oriented programming or scripting language, or a combination thereof, to communicate with or assist in the operation of a computer system, for example the computing device 1200. Alternatively, the methods 400, 500, 600 for determining a cluster configuration may be implemented in assembly or machine language. The language may be a compiled or interpreted language. Program code for implementing the methods and systems may be stored on a storage media or a device, for example a ROM, a magnetic disk, an optical disc, a flash drive, or any other suitable storage media or device. The program code may be readable by a general or special-purpose programmable computer for configuring and operating the computer when the storage media or device is read by the computer to perform the procedures described herein. Embodiments of the methods and systems may also be considered to be implemented by way of a non-transitory computer-readable storage medium having a computer program stored thereon. The computer program may comprise computer-readable instructions which cause a computer, or more specifically the processing unit 1202 of the computing device 1200, to operate in a specific and predefined manner to perform the functions described herein, for example those described in the methods 400, 500, 600.

Computer-executable instructions may be in many forms, including program modules, executed by one or more computers or other devices. Generally, program modules include routines, programs, objects, components, data structures, etc., that perform particular tasks or implement particular abstract data types. Typically, the functionality of the program modules may be combined or distributed as desired in various embodiments.

The embodiments described herein provide useful physical machines and particularly configured computer hardware arrangements. The embodiments described herein are directed to electronic machines and methods implemented by electronic machines adapted for processing and transforming electromagnetic signals which represent various types of information. The embodiments described herein pervasively and integrally relate to machines, and their uses; and the embodiments described herein have no meaning or practical applicability outside their use with computer hardware, machines, and various hardware components. Substituting the physical hardware particularly configured to implement various acts for non-physical hardware, using mental steps for example, may substantially affect the way the embodiments work. Such computer hardware limitations are clearly essential elements of the embodiments described herein, and they cannot be omitted or substituted for mental means without having a material effect on the operation and structure of the embodiments described herein. The computer hardware is essential to implement the various embodiments described herein and is not merely used to perform steps expeditiously and in an efficient manner.

The term “connected” or “coupled to” may include both direct coupling (in which two elements that are coupled to each other contact each other) and indirect coupling (in which at least one additional element is located between the two elements).

The technical solution of embodiments may be in the form of a software product. The software product may be stored in a non-volatile or non-transitory storage medium, which can be a compact disk read-only memory (CD-ROM), a USB flash disk, or a removable hard disk. The software product includes a number of instructions that enable a computer device (personal computer, server, or network device) to execute the methods provided by the embodiments.

The embodiments described in this document provide non-limiting examples of possible implementations of the present technology. Upon review of the present disclosure, a person of ordinary skill in the art will recognize that changes may be made to the embodiments described herein without departing from the scope of the present technology. For example, the similarity score may be for a given region of interest of two ballistic specimens or for the entire specimens. Yet further modifications could be implemented by a person of ordinary skill in the art in view of the present disclosure, which modifications would be within the scope of the present technology.

1. A method for generating clusters of ballistic specimens, the method comprising:
acquiring, using an image acquisition tool, topographic data for at least three ballistic specimens of at least one region of interest;
determining, at a computing device, from the topographic data, at least one parameter characterizing optimal toolmark alignment for every distinct pair of the at least three ballistic specimens, each ballistic specimen having a plurality of toolmarks formed thereon;
determining, at the computing device, from the topographic data, at least one pairwise similarity score associated with optimal toolmark alignment for every distinct pair of the at least three ballistic specimens;
determining, at the computing device, at least one triplet-wise consistency measure indicative of a consistency of optimal toolmark alignment for every distinct triplet of the at least three ballistic specimens; and
conducting, at the computing device, a cluster analysis based on the at least one similarity score and the at least one consistency measure to generate the clusters of ballistic specimens.

2. The method of claim 1, wherein the at least one consistency measure is determined based on a planar rotation of the at least three ballistic specimens having toolmarks of a same type.

3. The method of claim 1, wherein the at least one consistency measure is determined based on a planar translation of the at least three ballistic specimens having toolmarks of a same type.

4. The method of claim 1, wherein the at least one consistency measure is determined based on a planar rotation and a planar translation of the at least three ballistic specimens having toolmarks of a same type.

5. The method of claim 1, wherein the at least one consistency measure is determined based on a relative planar rotation of the at least three ballistic specimens having toolmarks of two different types.

6. The method of claim 1, wherein the at least one consistency measure is determined based on a relative planar translation of the at least three ballistic specimens having toolmarks of two different types.

7. The method of claim 1, wherein the at least one consistency measure is determined based on a relative planar translation and a relative planar rotation of the at least three ballistic specimens having toolmarks of two different types.

8. The method of claim 1, wherein the at least one consistency measure is determined based on a translation and a relative scale factor of the at least three ballistic specimens.

9. The method of claim 1, wherein the topographic data is acquired for the at least three ballistic specimens comprising cartridge cases.

10. The method of claim 1, wherein the topographic data is acquired for the at least three ballistic specimens comprising bullets.

11. The method of claim 10, wherein the at least one consistency measure is determined based on a phase score of land engraved area (LEA) comparisons of the bullets.

12. A system for generating clusters of ballistic specimens, the system comprising:
at least one processing unit; and
at least one non-transitory computer-readable memory having stored thereon program instructions executable by the processing unit for:
acquiring, using an image acquisition tool, topographic data for at least three ballistic specimens of at least one region of interest;
determining, at a computing device, from the topographic data, at least one parameter characterizing optimal toolmark alignment for every distinct pair of the at least three ballistic specimens, each ballistic specimen having a plurality of toolmarks formed thereon;
determining, at the computing device, from the topographic data, at least one pairwise similarity score associated with optimal toolmark alignment for every distinct pair of the at least three ballistic specimens;
determining, at the computing device, at least one triplet-wise consistency measure indicative of a consistency of optimal toolmark alignment for every distinct triplet of the at least three ballistic specimens; and
conducting, at the computing device, a cluster analysis based on the at least one similarity score and the at least one consistency measure to generate the clusters of ballistic specimens.

13. The system of claim 12, wherein the program instructions are executable by the processing unit for determining the at least one consistency measure based on a planar rotation and/or a planar translation of the at least three ballistic specimens having toolmarks of a same type.

14. The system of claim 12, wherein the program instructions are executable by the processing unit for determining the at least one consistency measure based on a relative planar rotation and/or a relative planar translation of the at least three ballistic specimens having toolmarks of two different types.

15. The system of claim 12, wherein the program instructions are executable by the processing unit for determining the at least one consistency measure based on a translation and a relative scale factor of the at least three ballistic specimens.

16. The system of claim 12, wherein the program instructions are executable by the processing unit acquiring the topographic data for the at least three ballistic specimens comprising cartridge cases.

17. The system of claim 12, wherein the program instructions are executable by the processing unit for acquiring the topographic data for the at least three ballistic specimens comprising bullets.

18. The system of claim 12, wherein the program instructions are executable by the processing unit for determining the at least one consistency measure based on a phase score of land engraved area (LEA) comparisons of the bullets.

19. A computer readable medium having stored thereon program code executable by a processor for:
acquiring, using an image acquisition tool, topographic data for at least three ballistic specimens of at least one region of interest;
determining, at a computing device, from the topographic data, at least one parameter characterizing optimal toolmark alignment for every distinct pair of the at least three ballistic specimens, each ballistic specimen having a plurality of toolmarks formed thereon;
determining, at the computing device, from the topographic data, at least one pairwise similarity score associated with optimal toolmark alignment for every distinct pair of the at least three ballistic specimens;
determining, at the computing device, at least one triplet-wise consistency measure indicative of a consistency of optimal toolmark alignment for every distinct triplet of the at least three ballistic specimens; and
conducting, at the computing device, a cluster analysis based on the at least one similarity score and the at least one consistency measure to generate clusters of that at least three ballistic specimens.
